(19) United States
(12) Patent Application Publication
(10) Pub. No.: US 2022/0338655 A1
(43) Pub. Date: Oct. 27, 2022

(54) ENVIRONMENT-FRIENDLY STRAW PAPER AND PREPARATION METHOD THEREOF, AND MANUFACTURING PROCESS OF PAPER STRAW

(71) Applicant: LEAFPAK COMPANY USA INC, Raleigh, NC (US)

(72) Inventor: Ling Dai, Hangzhou City (CN)

(21) Appl. No.: 17/241,866

(22) Filed: Apr. 27, 2021

(30) Foreign Application Priority Data
Apr. 22, 2021 (CN) 202110436728.9

(51) Int. Cl. A47G 21/18; B32B 1/08; B32B 29/02; B32B 29/06; B32B 7/08

(52) U.S. Cl. CPC A47G 21/18; B32B 1/08; B32B 29/02; B32B 29/06; B32B 7/08; B32B 2255/12; B32B 2255/28; B32B 2255/26; B32B 2255/20; B32B 2307/7265; B32B 2307/7163

(57) ABSTRACT

The invention discloses an environment-friendly straw paper and a preparation method thereof, and a manufacturing process of a paper straw, wherein the straw paper comprises a fibrous layer, barrier coating layers are respectively arranged on both sides of the fibrous layer, a heat-sealable coating layer is arranged outside of each of the barrier coating layers, and the heat-sealable coating layers can be bonded by heat- sealing. The straw paper has the following advantages: no wet strength agent is needed, its index parameters meet the requirements of food packaging paper, and through the optimization of the structure of the fiber composition, the control of the water content and the control of the stiffness of the base paper, the paperboard meets the process requirements of being able to roll up with a small radius of curvature and be rolled into a tubular shape with enough flexibility, the index of water resistance is that the water absorption value is not more than 10 g/m² for 30 min, and the paperboard can maintain good stiffness even after being soaked for a long time, so that the straw paper is completely recyclable, degradable, repulpable and compostable; in addition, the straw paper is also characterized by high bulk and stiffness, has zero plasticity and light weight, and has excellent properties such as good barrier properties, heat sealability and microwave heatablity.

### FIELD OF THE INVENTION

The invention relates to the field of paper production, and particularly to an environment-friendly straw paper and a preparation method thereof, and a manufacturing process of a paper straw.

### BACKGROUND OF THE INVENTION

With the ever-increasing consciousness of environmental protection, especially China's catering industry prohibits the use of non-degradable disposable plastic straws. Therefore, paper straws came into being. The paper straws are formed by surrounding straw paper. At present, the mainstream straw paper on the market is mainly re-sized base paper. In order to improve its liquid resistance, a certain amount of a wet strength agent needs to be added during production. The amount of the wet strength agent added depends on the final service requirements of the straw paper, generally 10-20 kg (based on a liquid wet strength agent with a solid content of 15%) per ton of paper. This straw paper mainly has the following disadvantages:

1. in the process of manufacturing straws, the straw paper must be bonded by using glue, whose smell affects the customer's experience, and the glue will precipitate during soaking in liquid, which may pose a food safety hazard;

2. in order to improve the liquid resistance of such straw paper, and maintain a certain stiffness and hardness during use, a wet strength agent is added, the current mainstream production process of wet strength agents on the market is an epichlorohydrin polymerization process, the finished wet strength agent has a high chloropropanol content, and the residual amount of chloropropanol as a strong carcinogen in the materials that are in direct contact with food packages has also been paid more and more attention; in the EU ISEGA test standards, it is clearly required that the residual amount of 1-3-dichloro-2-propanol DCP should be less than 2 μg/L and the residual amount of 3-chloro-1,2-propanediol MCPD should be less than 12 μg/L (EN645: cold water extraction method); subsequently, restrictions on chloropropanol are also immediately put forward in China's safety standards for food contact packaging materials; and in the current production process of straw paper, residual chloropropanol is a huge food safety risk;

3. due to the addition of a large amount of a wet strength agent, the recyclability of the used straws is challenged (the straws cannot be disintegrated in a conventional hydrapulper disintegration process, and a special wet-strength dissociating agent needs to be added, which increases the recycling cost and the recycling difficulty); and the addition of a wet strength agent also increases the degradation difficulty of the used straw paper (the wet strength agent itself is hardly microbiologically degradable);

4. this straw paper only can be produced into straws by a glue bonding process, there is no water-resistant layer on the inside and outside of the straws and liquid directly contacts the surface of base paper, which has high water resistance, but the base paper can easily absorb liquid and become soft after contacting the liquid for a long time, thus affecting the user experience; and

5. this straw paper only can be manufactured into straws by a glue +three- or more- layer straw paper winding process, resulting in excessively large straw wall thickness, and poor experience especially when consumers bite the straws.

Therefore, for the above technical problems, the inventor(s) of the present invention aims to provide an environment-friendly straw paper and a preparation method thereof, and a manufacturing process of a paper straw, and develops a recyclable, degradable and compostable double-sided water-based coated straw paper that is completely free of plastic and has a heat self-sealing function (ultrasonic wave or hot air), wherein the straw paper is manufactured in a single-slit forming manner into paper straws with double water-resistant coatings to replace the traditional viscose paper straws.

### SUMMARY OF THE INVENTION

To overcome the above disadvantages, an object of the invention is to provide an environment-friendly straw paper and a preparation method thereof, and a manufacturing process of a paper straw.

To achieve the above object, the invention employs the following technical solution: an environment-friendly straw paper comprises a fibrous layer, wherein barrier coating layers are respectively arranged on both sides of the fibrous layer, a heat-sealable coating layer is arranged outside of each of the barrier coating layers, and the heat- sealable coating layer is heat-sealable.

Preferably, the fibrous layer is made of base paper, the straw paper has an edge permeability of 95° C. hot water for 10 min, an edge permeability value of within 5 mm, a weight of 150-350 g/m², a longitudinal elongation of not less than 2.5% and a transverse elongation of not less than 9.0%, and the straw paper can be curled in a transverse direction. Through the optimization of the structure of the fiber composition, the control of the water content and the control of the stiffness of the base paper, the paperboard meets the process requirements of being able to roll up with a small radius of curvature and be rolled into a tubular shape with enough flexibility, which is the difficulty in the development of this base paper. It is the starting point of this patent to explore the optimization of the structure of the fiber composition and the control of the water content to control the elongation of the base paper, while the control of the elongation of the base paper mainly depends on the control of the barrier coating layers and the heat-sealable coating layers, and in the manufacturing process, since the base straw paper has very good flexibility, single-layer paper strips can be curled in the transverse direction, and then the heat-sealable coating layers can be quickly bonded together under the action of ultrasonic wave or hot air to achieve heat sealing.

Preferably, the barrier coating layer is a base coat and comprises the following parts of components by weight: 100 parts of porcelain clay, 80-130 parts of latex, 0.1-0.5 part of a rheological agent and 0.3-0.8 part of a water repellent agent. As used herein, the porcelain clay (flaky clay) has a diameter-to-thickness ratio of 20-40 and a small particle diameter (less than 2 um; not less than 96%), which can provide a coating with better flatness and covering performance; the latex is a relatively environment-friendly SA (styrene-acrylic latex) latex; the rheological agent is an amphoteric high polymer modified with acrylic acid, which improves the rheological property of the coating and reduces the formation of coating scratches; and the water repellent agent is a zirconium salt, which meets the requirements of food grade.

Preferably, the base coat further comprises 0.1-0.3 part of a dispersant, 0.1-0.5 part of sodium hydroxide, 0.3-1.0 part of carboxymethyl cellulose, 0.3-0.8 part of a lubricant and 0.1-0.3 part of a defoamer. The addition of these components can further improve the performance of the base coat.

Preferably, the heat-sealable coating layer is a top coat and comprises a modified organic polymer and an inorganic substance, and the inorganic substance comprises 0- 50% of the total mass. In other words, the modified organic polymer comprises 50-100% of the total mass. The modified organic polymer is mainly a mixture of multiple acrylate-modified polymers, wherein the balance between heat sealing and anti- sticking can be achieved by adjusting the types of the polymers, and the improvement of anti-sticking mainly depends on the addition of an inorganic substance which is selected from at least one of talc, porcelain clay and calcium carbonate.

A preparation method of an environment-friendly straw paper comprises the steps of: firstly, formulating a coating comprising a base coating and a top coating, the base coating comprising a front base coat and a back base coat, and the top coating comprising a front top coat and a back top coat; and

secondly, coating by a coating process: subjecting a front side of base paper to front base coating and drying followed by front top coating and drying, and subjecting the base paper to back base coating and drying followed by back top coating and drying, wherein the drying temperature is not less than 90° C.

Preferably, the coating is at least one of curtain coating, air knife coating, rod coating, blade coating and flexo-printing. Preferred coating may be curtain coating, air knife coating or rod coating.

Preferably, the coating process includes one of an inline coating process and an off- machine coating process. The inline coating manufacturing process is as follows: approach flow system - wire section - press section - front drying section - surface sizing - hard calendaring - coating - soft calendaring - rolling. The off-line coating manufacturing process is as follows: (1) approach flow system of base paper process - wire section - press section - front drying section - surface sizing - hard calendaring - rolling; and (2) coating process: base paper - coating - rolling.

Preferably, the front top coating is performed twice. under the same coating amount, multiple coating can improve the coverage of the coating.

A manufacturing process of a paper straw comprises the steps of: cutting straw paper into rectangular paper strips (generally, the perimeter of the section of the paper straw is 2-5 mm longer to achieve lapping), partially lapping the straw paper by a single-slit paper straw forming device, and bonding the lapped parts together under the action of ultrasonic wave or hot air to form a paper straw. In other words, the straw paper is cut into an elongated rectangle, encircled into a circle along the width direction of the rectangle and partially lapped, and due to the presence of the heat-sealable coating layers, the heat-sealable coating layers can be bonded together in the state of ultrasonic wave or hot air to ensure the forming of the straw.

The rectangular paper strips may also be bobbin paper cut from the environment- friendly straw paper along the paper machine direction according to the requirements of the diameter of a paper straw. The straw paper is partially lapped by a single-slit paper straw forming device, and the lapped parts are bonded together under the action of ultrasonic wave or hot air to form a paper straw.

In this manufacturing process, single-layer or multi-layer straw paper is wound on a paper straw core under the action of ultrasonic wave or hot air without using glue to form a paper straw.

The environment-friendly straw paper of the invention has the following beneficial effects: no wet strength agent is needed, its index parameters meet the requirements of food packaging paper, and through the optimization of the structure of the fiber composition, the control of the water content and the control of the stiffness of the base paper, the paperboard meets the process requirements of being able to roll up with a small radius of curvature and be rolled into a tubular shape with enough flexibility, the index of water resistance is that the water absorption value is not more than 10 g/m² for 30 min, and the paperboard can maintain good stiffness even after being soaked for a long time, so that the straw paper is completely recyclable, degradable, repulpable and compostable; in addition, the straw paper is also characterized by high bulk and stiffness, has zero plasticity and light weight, and has excellent properties such as good barrier properties, heat sealability and microwave heatablity.

The preparation method of an environment-friendly straw paper has the following beneficial effects: coating layers (two layers on the front side and two layers on the back side) are added on both sides of the fibrous layer (the coating amount is 3-15 g/m², preferably 3-8 g/m²); the front side is first coated once with a front base coat, which can modify the base paper to have better flatness and barrier properties, reduce the penetration of excessive coating on the front top coat into the base paper, improve the covering performance of the front top coating and save the amount of the front top coating; the front top coat is applied based on the front base coat and adjusted according to the temperature requirements of the coating; and the back side is coated with two layers in the same manner as the front side, thereby efficient manufacturing of the straw paper.

The manufacturing process of a paper straw has the following beneficial effects: the heat-sealable coating layers are quickly bonded in the state of ultrasonic wave or hot air by usingga single-slit paper straw forming device and the straw paper of the invention, thereby achieving rapid forming and efficient manufacturing of paper straws.

### BRIEF DESCRIPTION OF THE DRAWINGS

FIG. 1 is a schematic structural view of an environment-friendly straw paper;

FIG. 2 is a schematic sectional view of a paper straw;

FIG. 3 is a schematic structural view of the paper straw; and

FIG. 4 is a top view showing the structure of another paper straw.

In the Figures:

1. fibrous layer; 2. barrier coating layer; 3. heat-sealable coating layer.

### DETAILED DESCRIPTION OF THE INVENTION

The more preferred embodiments of the invention will be described below in detail in conjunction with the accompanying drawings, so that the advantages and features of the invention can be more readily understood by those skilled in the art, and therefore the protection scope of the invention will be more clearly and specifically defined.

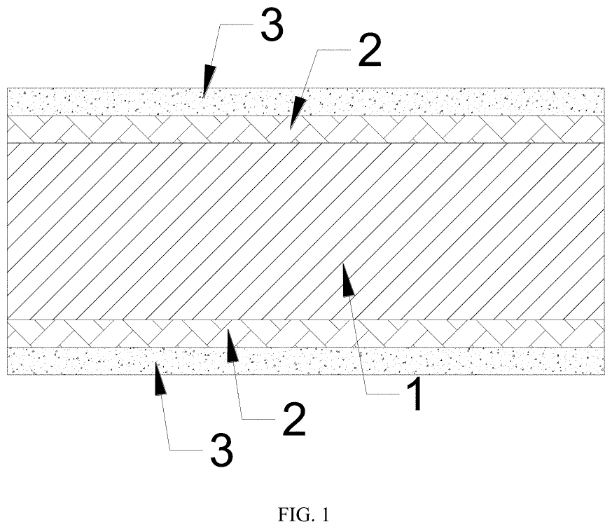

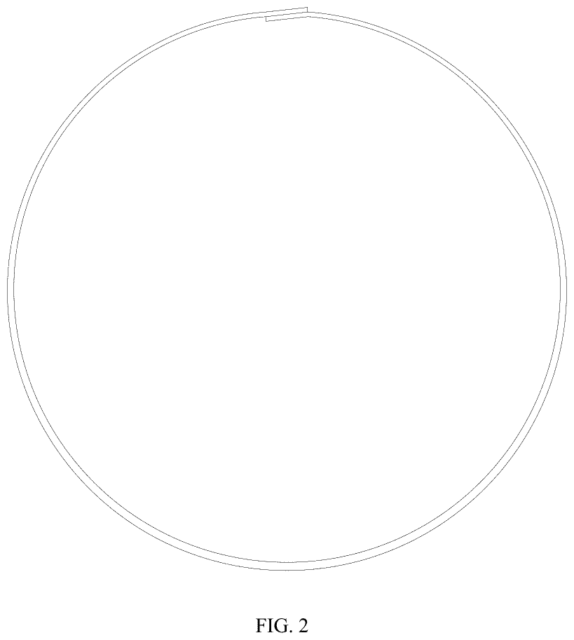

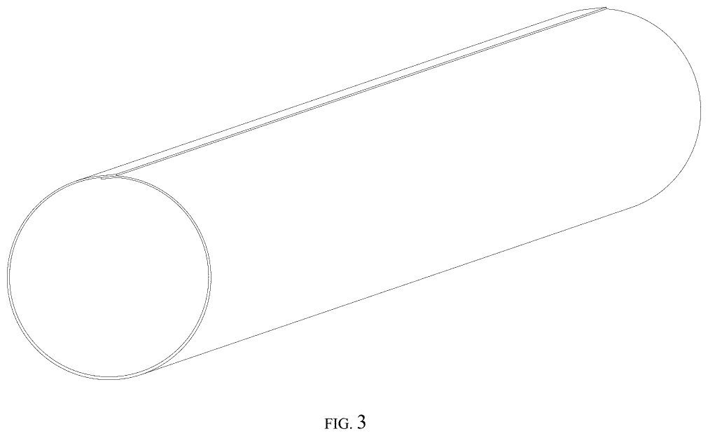

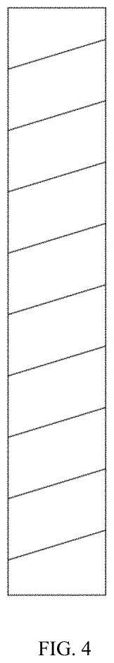

Referring to FIGS. 1-4, an environment-friendly straw paper comprises a fibrous layer 1, wherein barrier coating layers 2 are respectively arranged on both sides of the fibrous layer 1, a heat-sealable coating layer 3 is arranged outside of each of the barrier coating layers 2, and the heat-sealable coating layer 3 is heat-sealable.

The fibrous layer 1 is made of base paper, the straw paper has an edge permeability of 95° C. hot water for 10 min, an edge permeability value of within 5 mm, a weight of 150-350 g/m², a longitudinal elongation of not less than 2.5% and a transverse elongation of not less than 9.0%, and the straw paper can be curled in the transverse direction. Through the optimization of the structure of the fiber composition, the control of the water content and the control of the stiffness of the base paper, the paperboard meets the process requirements of being able to roll up with a small radius of curvature and be rolled into a tubular shape with enough flexibility, which is the difficulty in the development of this base paper. It is the starting point of this patent to explore the optimization of the structure of the fiber composition and the control of the water content to control the elongation of the base paper, while the control of the elongation of the base paper mainly depends on the control of the barrier coating layers 2 and the heat-sealable coating layers 3, and in the manufacturing process, since the base straw paper has very good flexibility, single-layer paper strips can be curled in the transverse direction, and then the heat-sealable coating layers 3 can be quickly bonded together under the action of ultrasonic wave or hot air to achieve heat sealing.

The barrier coating layer 2 is a base coat and comprises the following parts of components by weight: 100 parts of porcelain clay, 80-130 parts of latex, 0.1-0.5 part of a rheological agent and 0.3-0.8 part of a water repellent agent. As used herein, the porcelain clay (flaky clay) has a diameter-to-thickness ratio of 20-40 and a small particle diameter (less than 2 um; not less than 96%), which can provide a coating with better flatness and covering performance; the latex is a relatively environment-friendly SA (styrene-acrylic latex) latex; the rheological agent is an amphoteric high polymer modified with acrylic acid, which improves the rheological property of the coating and reduces the formation of coating scratches; and the water repellent agent is a zirconium salt, which meets the requirements of food grade.

The base coat further comprises 0.1-0.3 part of a dispersant, 0.1-0.5 part of sodium hydroxide, 0.3-1.0 part of carboxymethyl cellulose, 0.3-0.8 part of a lubricant and 0.1- 0.3 part of a defoamer. The addition of these components can further improve the performance of the base coat.

The heat-sealable coating layer 3 is a top coat and comprises a modified organic polymer and an inorganic substance, and the inorganic substance comprises 0-50% of the total mass. In other words, the modified organic polymer comprises 50-100% of the total mass. The modified organic polymer is mainly a mixture of multiple acrylate- modified polymers, wherein the balance between heat sealing and anti-sticking can be achieved by adjusting the types of the polymers, and the improvement of anti-sticking mainly depends on the addition of an inorganic substance which is selected from at least one of talc, porcelain clay and calcium carbonate. Mixtures of acrylate-modified polymers are for example, polymers of butyl 2-acrylate with butyl 2-methyl-2-acrylate, 2-(dimethylamino) ethyl methacrylate and methyl methacrylate; polymers of 2-methyl 2-acrylate, ethyl 2-acrylate and methyl 2-methyl-2-acrylate; polymers of 2- (dimethylamino) ethyl 2-methyl-2-acrylate with methyl 2-methyl-2-acrylate; polymers of methyl 2-methyl-2-acrylate with styrene and maleic anhydride; polymers of ethyl 2- methyl-2-acrylate with methyl 2-acrylate; polymers of 2-methyl 2-acrylate with butyl 2-methyl-2-acrylate and methyl 2-methyl-2-acrylate; and polymers of 2-methyl 2- acrylate with methyl 2-methyl-2-acrylate.

A preparation method of an environment-friendly straw paper comprises the steps of: firstly, formulating a coating comprising a base coating and a top coating, the base coating comprising a front base coat and a back base coat, and the top coating comprising a front top coat and a back top coat; and

secondly, coating by a coating process: subjecting a front side of base paper to front base coating and drying followed by front top coating and drying, and subjecting the base paper to back base coating and drying followed by back top coating and drying, wherein the drying temperature is not less than 90° C.

The coating is at least one of curtain coating, air knife coating, rod coating, blade coating and flexo-printing. Preferred coating may be curtain coating, air knife coating or rod coating.

The coating process includes one of an inline coating process and an off-machine coating process. The inline coating manufacturing process is as follows: approach flow system - wire section - press section - front drying section - surface sizing - hard calendaring - coating - soft calendaring - rolling. The off-line coating manufacturing process is as follows: (1) approach flow system of base paper process - wire section - press section - front drying section - surface sizing - hard calendaring - rolling; and (2) coating process: base paper - coating - rolling.

The front top coating is performed twice. under the same coating amount, multiple coating can improve the coverage of the coating.

A manufacturing process of a paper straw comprises the steps of: cutting straw paper into rectangular paper strips (generally, the perimeter of the section of the paper straw is 2-5 mm longer to achieve lapping), partially lapping the straw paper by a single-slit paper straw forming device, and bonding the lapped parts together under the action of ultrasonic wave or hot air to form a paper straw. In other words, the straw paper is cut into an elongated rectangle, encircled into a circle along the width direction of the rectangle and partially lapped, and due to the presence of the heat-sealable coating layers 3, the heat-sealable coating layers 3 can be bonded together in the state of ultrasonic wave or hot air to ensure the forming of the straw.

The rectangular paper strips may also be bobbin paper cut from the environment- friendly straw paper along the paper machine direction according to the requirements of the diameter of a paper straw. The straw paper is partially lapped by a single-slit paper straw forming device, and the lapped parts are bonded together under the action of ultrasonic wave or hot air to form a paper straw.

In this manufacturing process, single-layer or multi-layer straw paper is wound on a paper straw core under the action of ultrasonic wave or hot air without using glue to form a paper straw.

The environment-friendly straw paper of the invention has the following beneficial effects: no wet strength agent is needed, its index parameters meet the requirements of food packaging paper, and through the optimization of the structure of the fiber composition, the control of the water content and the control of the stiffness of the base paper, the paperboard meets the process requirements of being able to roll up with a small radius of curvature and be rolled into a tubular shape with enough flexibility, the index of water resistance is that the water absorption value is not more than 10 g/m² for 30 min, and the paperboard can maintain good stiffness even after being soaked for a long time, so that the straw paper is completely recyclable, degradable, repulpable and compostable; in addition, the straw paper is also characterized by high bulk and stiffness, has zero plasticity and light weight, and has excellent properties such as good barrier properties, heat sealability and microwave heatablity. The preparation method of an environment-friendly straw paper has the following beneficial effects: coating layers (two layers on the front side and two layers on the back side) are added on both sides of the fibrous layer 1 (the coating amount is 3-15 g/m², preferably 3-8 g/m²); the front side is first coated once with a front base coat, which can modify the base paper to have better flatness and barrier properties, reduce the penetration of excessive coating on the front top coat into the base paper, improve the covering performance of the front top coating and save the amount of the front top coating; the front top coat is applied based on the front base coat and adjusted according to the temperature requirements of the coating; and the back side is coated with two layers in the same manner as the front side, thereby efficient manufacturing of the straw paper.

The manufacturing process of a paper straw has the following beneficial effects: the heat-sealable coating layers 3 are quickly bonded in the state of ultrasonic wave or hot air by using a single-slit paper straw forming device and the straw paper of the invention, thereby achieving rapid forming and efficient manufacturing of paper straws. Straws formed by bonding with uncoated base paper were used as the control group.

### Example 1

Front base coating: the coating was formulated from 100 parts of porcelain clay, 80 parts of latex, 0.2 part of a dispersant, 0.3 part of NaOH, 0.4 part of a water repellent agent, 0.8 part of carboxymethyl cellulose, 0.5 part of a lubricant, 0.1 part of a defoamer and 0.2 part of a rheological agent; and single coating was performed with a total coating amount of 6.0 g/m² and a drying temperature of 90° C.

Front top coating: the coating was formulated from 90% of an acrylate-modified polymer and 10% of an inorganic substance; and double coating was performed with a total coating amount of 7.2 g/m² and a drying temperature of 110° C.

Back base coating: the coating was formulated from 100 parts of porcelain clay, 80 parts of latex, 0.2 part of a dispersant, 0.3 part of NaOH, 0.4 part of a water repellent agent, 0.8 part of carboxymethyl cellulose, 0.5 part of a lubricant, 0.1 part of a defoamer and 0.2 part of a rheological agent; and single coating was performed with a total coating amount of 6.0 g/m² and a drying temperature of 90° C. Back top coating: the coating was formulated from 100% of an acrylate-modified polymer and 0% of an inorganic substance; and double coating was performed with a total coating amount of 4.6 g/m² and a drying temperature of 120° C.

### Example 2

Front base coating: the coating was formulated from 100 parts of porcelain clay, 90 parts of latex, 0.2 part of a dispersant, 0.3 part of NaOH, 0.4 part of a water repellent agent, 0.8 part of carboxymethyl cellulose, 0.5 part of a lubricant, 0.1 part of a defoamer and 0.2 part of a rheological agent; and single coating was performed with a total coating amount of 6.0 g/m² and a drying temperature of 100° C.

Front top coating: the coating was formulated from 90% of an acrylate-modified polymer and 10% of an inorganic substance; and double coating was performed with a total coating amount of 6.8 g/m² and a drying temperature of 100° C.

Back base coating: the coating was formulated from 100 parts of porcelain clay, 90 parts of latex, 0.2 part of a dispersant, 0.3 part of NaOH, 0.4 part of a water repellent agent, 0.8 part of carboxymethyl cellulose, 0.5 part of a lubricant, 0.1 part of a defoamer and 0.2 part of a rheological agent; and single coating was performed with a total coating amount of 6.0 g/m² and a drying temperature of 100° C.

Back top coating: the coating was formulated from 90% of an acrylate-modified polymer and 10% of an inorganic substance; and double coating was performed with a total coating amount of 7.2 g/m² and a drying temperature of 110° C.

### Example 3

Front base coating: the coating was formulated from 100 parts of porcelain clay (flaky clay), 100 parts of latex, 0.15 part of a dispersant, 0.25 part of NaOH, 0.4 part of a water repellent agent, 0.8 part of carboxymethyl cellulose, 0.5 part of a lubricant, 0.1 part of a defoamer and 0.2 part of a rheological agent; and single coating was performed with a total coating amount of 6.0 g/m² and a drying temperature of 110° C.

Front top coating: the coating was formulated from 90% of an acrylate-modified polymer and 10% of an inorganic substance; and double coating was performed with a total coating amount of 6.8 g/m² and a drying temperature of 110° C.

Back top coating: the coating was formulated from 90% of an acrylate-modified polymer and 10% of an inorganic substance; and double coating was performed with a total coating amount of 8.0 g/m² and a drying temperature of 120° C. Back base coating: the coating was formulated from 100 parts of porcelain clay, 100 parts of latex, 0.2 part of a dispersant, 0.25 part of NaOH, 0.4 part of a water repellent agent, 0.8 part of carboxymethyl cellulose, 0.5 part of a lubricant, 0.1 part of a defoamer and 0.2 part of a rheological agent; and single coating was performed with a total coating amount of 6.0 g/m² and a drying temperature of 110° C.

Coatings were arranged on both sides of the base paper according to the formulations of Examples 1-3, and the base paper was manufactured into paper straws with the same size and thickness as the control group according to the paper straw manufacturing process for testing.

The test items included: respectively soaking different straws in hot water at 95 ° C.±3 for 30 min, in coffee for 4 h, in lactic acid for 30 min and in a penetrant (a 1% hand sanitizer) for 15 min; and the recyclability test of the straws. The specific test steps were performed as follows: the device was a laboratory hydrapulper with the following operation: the prepared pieces (5 cm) with an oven dry weight of 500 g were placed in a tank, 40° C. water was added until the concentration was 9% and then the pieces were soaked for 5 min; a cover was closed, a power source and an electric heating button were turned on, the speed of a control panel was adjusted to a minimum of 145 rpm, a Rev button was pressed to start disintegration, and the speed was continuously increased to 410 rpm until the waste paper was fully disintegrated, wherein this process took 10 min. The recyclability was tested as follows: the crushed pulp was subjected to sheet forming (without using any slag removal device), and no large pieces on a sheet former demonstrated recyclability.

Performance Comparison Table of Test Results

| Test items | | | | |
|---|---|---|---|---|
| (soaking paper | Control | | | |
| straw therein) | group | Example 1 | Example 2 | Example 3 |
| Hot water at | No | No | No | No |
| 95° C. ± | softening | softening | softening | softening |
| 3 for 30 min | | | | |
| Coffee for 4 h | Softened | No | No | No |
| | | softening | softening | softening |
| Lactic acid | No | No leakage | No leakage | No leakage |
| for 30 min | softening | | | |
| Penetrant | Penetrated | No | No | No |
| (1% hand | | penetration | penetration | penetration |
| sanitizer) | | | | |
| for 15 min | | | | |
| Repulpable | No | Yes | Yes | Yes |
| (recyclable) | | | | |

According to the above experiment, the environment-friendly straw does not contain plastic components, and is completely recyclable, degradable, repulpable and compostable; in addition, the product is also characterized by high bulk and stiffness, has zero plasticity and light weight, and has excellent properties such as good barrier properties, heat sealability and microwave heatablity.

The above embodiments are only for the purpose of describing the technical concept and features of the invention, and aim at enabling the persons skilled in the art to understand and implement the contents of the invention, and therefore cannot limit the protection scope of the invention. Any equivalent change or modification made based on the spirit and essence of the invention shall be covered within the protection scope of the invention.

1. An environment-friendly straw paper, comprising a fibrous layer, barrier coating layers being respectively arranged on both sides of the fibrous layer, a heat-sealable coating layer being also arranged outside of each of the barrier coating layers, and the heat-sealable coating layer being heat-sealable.

2. The environment-friendly straw paper according to claim 1, wherein the fibrous layer is made of base paper, the straw paper has an edge permeability of 95° C. hot water for 10 min, an edge permeability value of within 5 mm, a weight of 150-350 g/m², a longitudinal elongation of not less than 2.5% and a transverse elongation of not less than 9.0%, and the straw paper can be curled in the transverse direction.

3. The environment-friendly straw paper according to claim 1, wherein the barrier coating layer is a base coat and comprises the following parts of components by weight:
100 parts of porcelain clay, 80-130 parts of latex, 0.1-0.5 part of a rheological agent and 0.3-0.8 part of a water repellent agent.

4. The environment-friendly straw paper according to claim 3, wherein the base coat further comprises 0.1-0.3 part of a dispersant, 0.1-0.5 part of sodium hydroxide, 0.3- 1.0 part of carboxymethyl cellulose, 0.3-0.8 part of a lubricant and 0.1-0.3 part of a defoamer.

5. The environment-friendly straw paper according to claim 1, wherein the heat- sealable coating layer is a top coat and comprises a modified organic polymer and an inorganic substance, and the inorganic substance comprises 0-50% of the total mass.

6. A preparation method of an environment-friendly straw paper, comprising the steps of:
firstly, formulating a coating comprising a base coating and a top coating, the base coating comprising a front base coat and a back base coat, and the top coating comprising a front top coat and a back top coat; and
secondly, coating by a coating process: subjecting a front side of base paper to front base coating and drying followed by front top coating and drying, and subjecting the base paper to back base coating and drying followed by back top coating and drying, wherein the drying temperature is not less than 90° C.

7. The preparation method of an environment-friendly straw paper according to claim 6, wherein the coating is at least one of curtain coating, air knife coating, rod coating, blade coating and flexo-printing.

8. The environment-friendly straw paper according to claim 6, wherein the front top coating and the back top coating are respectively performed twice.

9. A manufacturing process of a paper straw, wherein the straw paper is cut into rectangular paper strips along the paper machine direction and partially lapped by a single-slit paper straw forming device, and the lapped parts are bonded together under the action of ultrasonic wave or hot air to form a paper straw.

10. A manufacturing process of a paper straw, wherein straw paper is cut into rectangular paper strips along the paper machine direction, and single-layer or multi- layer straw paper is wound on a paper straw core under the action of ultrasonic wave or hot air by a conventional paper straw machine without using glue to form a paper straw.
